(19) United States
(12) Patent Application Publication
(10) Pub. No.: US 2011/0074681 A1
(43) Pub. Date: Mar. 31, 2011

(54) COMPUTER MOUSE

(75) Inventor: AN-GANG LIANG, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/610,366

(22) Filed: Nov. 2, 2009

(30) Foreign Application Priority Data
Sep. 29, 2009 (CN) 200910307983.2

(51) Int. Cl. G09G 5/08

(52) U.S. Cl. 345/163

(57) ABSTRACT

A computer mouse includes a shell and a cable. The shell includes a planar base wall, a top wall opposite to the base wall, a front wall interconnecting front edges of the top and base walls, a left sidewall interconnecting left edges of the top and base walls, and a right sidewall interconnecting right edges of the top and base walls. At least one scrolling wheel is formed on one of the left and right sidewalls. A pair of mechanical buttons are formed on the top wall. An opening is defined in the front wall receiving a socket therein. The socket has a plurality of conductive pins. An end of the cable forms a connector with a plurality of electric pins. The connector is detachablely inserted in the socket with the electric pins thereof connected with the conductive pins.

### BACKGROUND

1. Technical Field

The present disclosure relates to computer mice.

2. Description of Related Art

Computers typically include a host computer, a display, a keyboard, and a computer mouse. The computer mouse is connected to the host computer by a wire for controlling, for example, motion of a cursor on the display. Typically, a computer mouse includes two mechanical buttons and a scrolling wheel arranged between the two mechanical buttons. The index finger and the middle finger of a user respectively click the two mechanical buttons or roll the scrolling wheel to select object(s) shown on the display. However, after a period, repeated clicks of the mechanical buttons and rolling the scrolling wheel of the computer mouse only by two fingers can possibly result in user fatigue and even cause or exacerbate carpal tunnel syndrome in the user.

Therefore, it is desirable to provide a computer mouse which can overcome the above limitations.

### BRIEF DESCRIPTION OF THE DRAWINGS

FIG. 1 is an isometric, assembled view of a computer mouse according to an exemplary embodiment.

FIG. 2 is an exploded view of the computer mouse of FIG. 1.

FIG. 3 is similar to FIG. 1, but viewed from another aspect.

FIG. 4 is a top plane view of the computer mouse of FIG. 1.

FIG. 5 is an enlarged view of a circle V of FIG. 2.

### DETAILED DESCRIPTION

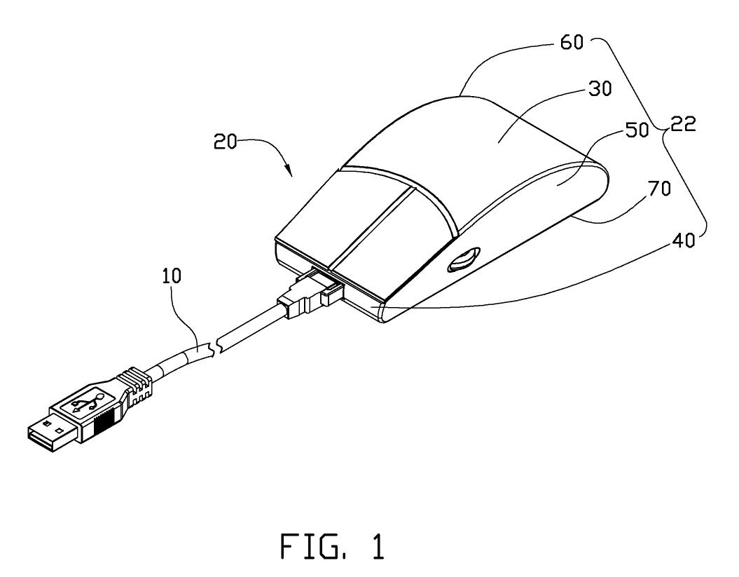

FIG. 1 shows a computer mouse according to an exemplary embodiment that includes a shell 22 and a USB cable 10.

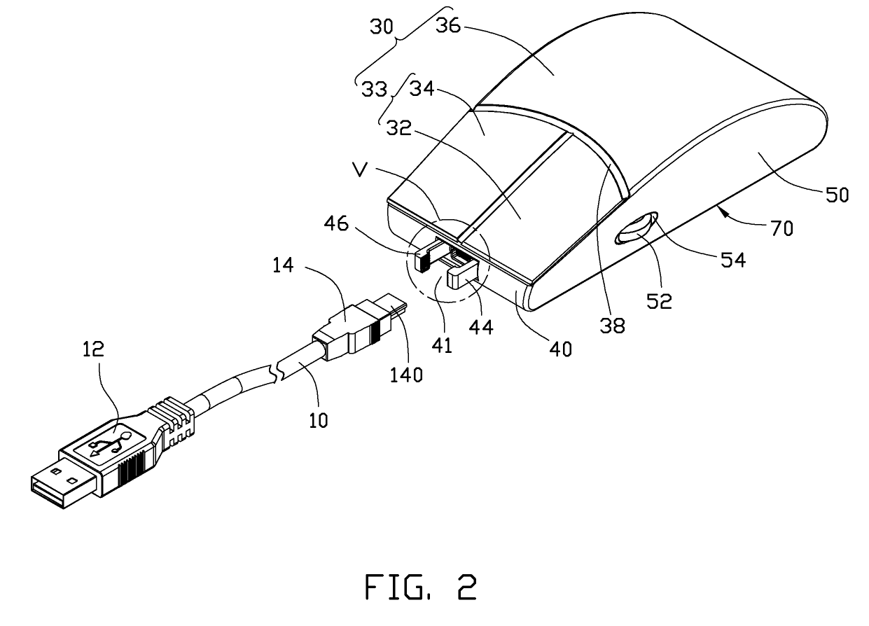

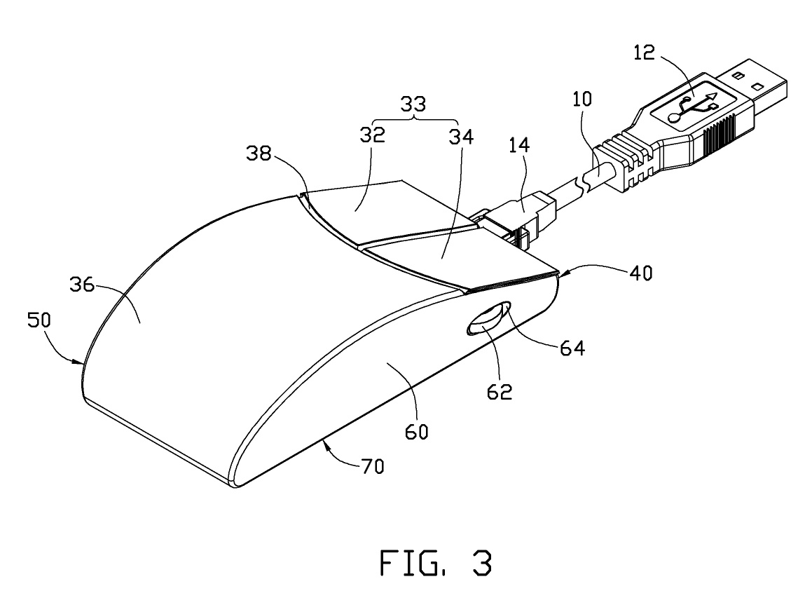

Referring to FIGS. 2 and 3, the USB cable 10 is adapted for electrically connecting the computer mouse to a computer. One end of the USB cable 10 forms a USB plug 12 which can be inserted into a corresponding socket of the computer, and an opposite end of the USB cable 10 forms a connector 14 which can be connected to the shell 22 of the computer mouse. The connector 14 is flat, and has a plurality of electric pins 140 formed therein.

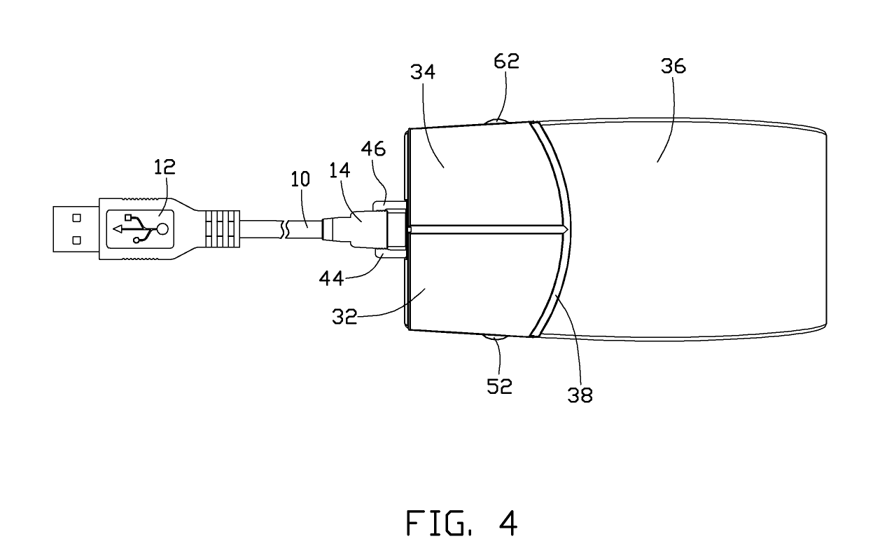

Referring to FIGS. 1 and 4, the shell 22 includes a top wall 30, a front wall 40, a left sidewall 50, a right sidewall 60, and a base wall 70. In this embodiment, two mechanical buttons (i.e., a left mechanical button 32 and a right mechanical button 34) are formed on the top wall 30, a left scrolling wheel 52 is formed on the left sidewall 50, and a right scrolling wheel 62 is formed on the right sidewall 60 of the shell 22. It is to be understood that the number of the mechanical buttons 32, 34 and the scrolling wheels 52, 62 can be modified. A chamber is defined in the shell 22 for housing a circuit board (not shown) therein. The circuit board has circuits formed thereon. The circuits are configured to receive pulses generated by the two mechanical buttons 32, 34 and the two scrolling wheels 52, 62, and to convert the pulses into control signals to control motion of a cursor on a display of the computer.

The base wall 70 of the shell 22 is planar, and has a substantially rectangular profile.

Referring to FIGS. 2 and 3 again, the top wall 30 of the shell 22 is opposite to the base wall 70, and is convex in profile. The top wall 30 includes an input section 33 and a support section 36. The input section 33 is located at a front side of the top wall 30 adjacent to the USB cable 10, and the support section 36 is at a rear side of the top wall 30. A curved junction 38 is formed between the input section 33 and the support section 36. The two mechanical buttons 32, 34 are formed on the input section 33, and are similar in structure. The support section 36 is shaped so as to more comfortably fit a palm of a hand of a user when the computer mouse is in use. The support section 36 is arched, and is smoothly connected to a rear edge of the base wall 70.

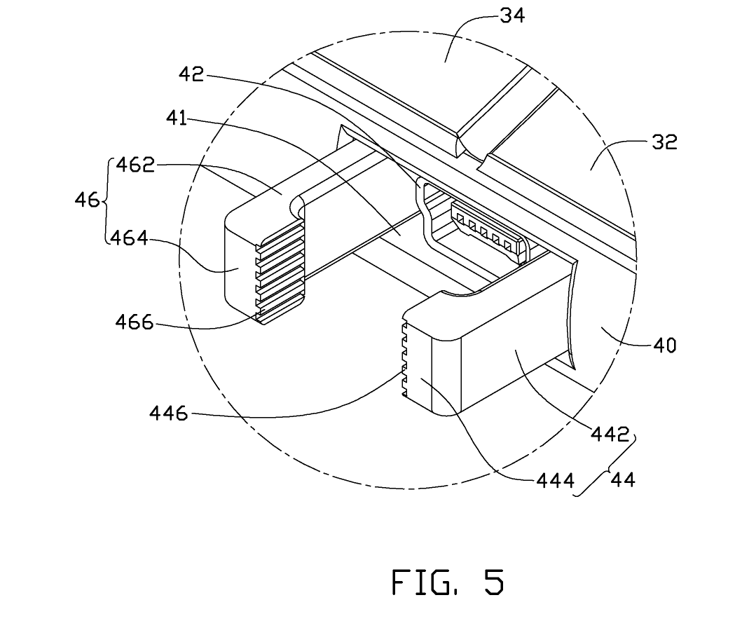

Referring to FIG. 5 at the same time, the front wall 40 interconnects a front edge of the top wall 30 and a front edge of the base wall 70. The front wall 40 is elongated in a left-to-right direction, and is substantially perpendicular to the base wall 70. An opening 41 is defined in a middle portion of the front wall 40. In this embodiment the opening 41 is rectangular. A socket 42 is formed in the opening 41 for matching with the connector 14 of the USB cable 10. A plurality of conductive pins are formed in the socket 42 and connected to the circuits of the circuit board electrically.

For the present computer mouse, it is easy to connect/disconnect the USB cable 10 to/from the shell 22 by inserting/pulling apart the connector 14 into/from the socket 42. To use the computer mouse, the user can respectively connect the USB plug 12 and the connector 14 of the USB cable 10 to the computer and the socket 42 of the shell 22, thus the conductive pins of the socket 42 and the electric pins 140 of the connector 14 are electrically connected and the computer mouse is enabled. When the computer mouse is not needed, the user can disconnect the USB cable 10 from the computer and the shell 22 of the computer mouse. Thus the USB cable 10 and the shell 22 of the computer mouse can be disposed separately; accordingly, it is convenient to pack and take along to other locations.

A pair of elastic clips 44, 46 are formed in the opening 41, and respectively located at left and right sides of the socket 42. The clips 44, 46 can be integrally made with the shell 22. Alternatively, the clips 44, 46 and the shell 22 can be formed separately and then assembled together. Each of the clips 44, 46 is substantially L-shaped, and includes a connecting pole 442, or 462 extending outwardly from the shell 22, and a hook 444, or 464 extending perpendicularly from the connecting pole 442, or 462 towards the other clip 46, 44. The connecting poles 442, 462 of the clips 44, 46 are parallel to each other. The hooks 444, 464 of the clips 44, 46 are collinear. A distance between the hooks 444, 464 is not longer than a width of the connector 14 of the USB cable 10, but is smaller than a distance between the connecting poles 442, 462. Each hook 444, 464 has a working face confronting the other hook 464, 444. A plurality of teeth 446, 466 are formed on each of the working faces of the hooks 444, 464.

Since the clips 44, 46 are elastic, when the USB cable 10 is connected to the socket 42 of the shell 22, the clips 44, 46 can deform to lengthen the distance therebetween, thus the connector 14 of the USB cable 10 can be inserted into the socket 42 easily. After assembly, the clips 44, 46 resume a free state, thus the connector 14 of the USB cable 10 is engaged between the working faces of the hooks 444, 464 for the distance between the hooks 444, 464 not larger than the width of the connector 14. Further, the teeth 446, 466 on the working faces enhance friction between the USB cable 10 and the clips 44, 46, thus preventing the USB cable 10 from falling from the shell 22.

The left sidewall 50 and the right sidewall 60 are similar in structure. The left sidewall 50 interconnects left edges of the top wall 30, the base wall 70 and the front wall 40 (as shown in FIG. 2). The right sidewall 60 interconnects right edges of the top wall 30, the base wall 70 and the front wall 40 (as shown in FIG. 3). A slot 54, 64 is defined in each of the left sidewall 50 and the right sidewall 60. The slots 54, 64 are located corresponding to the input section 33 of the top wall 30. The left scrolling wheel 52 is rotatably received in the slot 54 of the left sidewall 50, and the right scrolling wheel 62 is rotatably received in the slot 64 of the right sidewall 60. The two scrolling wheels 52, 62 are similar in structure. Each of the two scrolling wheels 52, 62 rotates around a vertical axis. That is, each of the two scrolling wheels 52, 62 rolls in a front-to-rear direction.

In this embodiment, the left scrolling wheel 52 is used for controlling a latitudinal motion of the cursor on the display, while the right scrolling wheel 62 is used for controlling a longitudinal motion of the cursor on the display. Functions of the left scrolling wheel 52 and the right scrolling wheel 62 can be exchanged to match a habit of the user, i.e., the left scrolling wheel 52 used for controlling a longitudinal motion of the cursor on the display, while the right scrolling wheel 62 used for controlling a latitudinal motion of the cursor on the display. Details about how to use the present computer mouse are given below.

Taking a right handed user for example, the user's palm is supported by the support section 36 of the top wall 30 with the index finger on the left mechanical button 32 and the middle finger on the right mechanical button 34. The thumb is at a left side of the computer mouse and corresponds to the left scrolling wheel 52, while the ring finger is at a right side of the computer mouse and corresponds to the right scrolling wheel 62. The index finger presses the left mechanical button 32 to actuate the left mechanical button 32, and similarly, the middle finger can press the right mechanical button 34 to actuate the left mechanical button 32. The thumb rolls the left scrolling wheel 52 to actuate the left scrolling wheel 52, and the ring finger rolls the right scrolling wheel 62 to actuate the right scrolling wheel 62. Correspondingly, a signal pulse is generated and transferred to the circuits for interpretation into a predetermined mouse function when either one of the two mechanical buttons 32, 34 and the two scrolling wheels 52, 62 is actuated, for example, a single click at a position of the cursor, a click and hold action at the position of the cursor, a double-click at the position of the cursor, etc.. Thus the two mechanical buttons 32, 34 and the two scrolling wheels 52, 62 are handled by four different fingers of the user. Pressure on each finger while using the present computer mouse is greatly reduced, and users can remain comfortable even for extended periods of use. Accordingly, fatigue, irritation, and even carpal tunnel syndrome can be avoided.

Alternatively, the present computer mouse can be handled by left handed users. In such a situation, the index finger is on the right mechanical button 34 for actuating the right mechanical button 34, the middle finger is on the left mechanical button 32 for actuating the left mechanical button 32, the thumb is at the right side of the computer mouse for actuating the right scrolling wheel 62, and the ring finger is at the left side of the computer mouse for actuating the left scrolling wheel 52. Accordingly, the two mechanical buttons 32, 34 and the two scrolling wheels 52, 62 are handled by four different fingers, and thus a load of each finger is much reduced.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A computer mouse comprising:
a shell comprising a base wall, a top wall, and a pair of sidewalls respectively interconnecting lateral edges of the base wall and the top wall;
a pair of mechanical buttons formed on the top wall; and
at least one scrolling wheel being formed on the pair of sidewalls.

2. The computer mouse of claim 1, wherein the at least one scrolling wheel comprises two scrolling wheels respectively formed on the pair of sidewalls, one of the two scrolling wheel being adapted for controlling a latitudinal motion of a cursor on a display of a computer, and the other scrolling wheel being configured for controlling a longitudinal motion of the cursor on the display.

3. The computer mouse of claim 1, wherein a position of the at least one scrolling wheel corresponds to the mechanical buttons.

4. The computer mouse of claim 1, wherein the at least one scrolling wheel is operable to rotate around a vertical axis when the computer mouse is in use.

5. The computer mouse of claim 1, wherein the shell further comprises a front wall interconnecting front edges of the top wall, the base wall, and the pair of sidewalls, the front wall defining an opening receiving a socket therein, the socket forming a plurality of conductive pins.

6. The computer mouse of claim 5, further comprising a USB cable, the USB cable forming a connector matching with the socket at an end thereof, the connector being detachablely inserted in the socket.

7. The computer mouse of claim 6, wherein the connector forms a plurality of electric pins which are connected with the conductive pins of the socket when the connector is inserted in the socket.

8. The computer mouse of claim 6, wherein a pair of clips are formed at opposite sides of the socket, each of the pair of clips comprising a connecting pole extending from the shell and a hook extending perpendicular from the connecting pole towards the other one of the pair of clips, a distance between the hooks being not larger than a width of the connector of the USB cable, the connector being engaged between the hooks of the pair of clips.

9. The computer mouse of claim 8, wherein each hook comprises a working face abutting the connector of the USB cable, a plurality of teeth being formed on the working face for enhancing friction between the clip and the USB cable.

10. A computer mouse, comprising:
a shell comprising:
a planar base wall;
a top wall opposite to the base wall;
a left sidewall interconnecting left edges of the top wall and the base wall;
a right sidewall interconnecting right edges of the top wall and the base wall; and
a front wall interconnecting front edges of the top wall, the base wall, the left sidewall and the right sidewall, the front wall defining an opening therein;
at least one scrolling wheel being formed on one of the left sidewall and the right sidewall;
a pair of mechanical buttons being formed on the top wall;
a socket disposed in the opening of the front wall, comprising a plurality of conductive pins; and
a cable forming a connector at an end thereof, the connector comprising a plurality of electric pins and being detachablely inserted in the socket with the electric pins thereof connected with the conductive pins.

11. The computer mouse of claim 10, wherein a pair of clips are formed at opposite sides of the socket, the connector being engaged between the pair of clips.

12. The computer mouse of claim 11, wherein each of the pair of clips comprises a connecting pole extending from the shell and a hook extending perpendicular from the connecting pole towards the other one of the pair of clips, a distance between the hooks being not larger than a width of the connector of the USB cable, the connector being engaged between the hooks of the pair of clips.

13. The computer mouse of claim 12, wherein each hook comprises a working face abutting the connector of the cable, a plurality of teeth being formed on the working faces for enhancing friction between the clips and the cable.

14. The computer mouse of claim 10, wherein the cable is a USB cable, and forms a USB plug at an end thereof opposite to the connector.

15. The computer mouse of claim 10, wherein the at least one scrolling wheel comprises two scrolling wheels respectively formed on the left sidewall and the right sidewall, one of the two scrolling wheel being adapted for controlling a latitudinal motion of a cursor on a display of a computer, and the other scrolling wheel being configured for controlling a longitudinal motion of the cursor on the display.
